(19) United States
(12) Patent Application Publication
(10) Pub. No.: US 2007/0127666 A1
(43) Pub. Date: Jun. 7, 2007

(54) System and method for enhancing capabilities of simple phones

(76) Inventors: Michael Rabinovich, Modiin (IL); Matia Marcu, Natanya (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/291,863

(22) Filed: Dec. 1, 2005

(51) Int. Cl. H04M 3/42

(52) U.S. Cl. 379/201.12

(57) ABSTRACT

A communication unit adapted to provide enhanced services to a simple phone user, the communication unit includes a network interface, a simple phone interface and a terminal server module that is connected to the network interface and to the simple phone interface. The communication unit is adapted to monitor symbols that are dialed by the user of the simple phone; determine if the dialed symbols form a predefined code that is associated with an enhanced service; selectively send information to be displayed on the display of the simple phone; monitor the symbols that are dialed by the user; and react to the dialed symbols such as to provide multiple enhanced services that include incoming call handling and exchanging messages. A method for providing enhanced services to simple phone users, the method includes: monitoring symbols that are dialed by the user of the simple phone, determining if the dialed symbols form a predefined code that is associated with an enhanced service, selectively sending information to be displayed on the display of the simple phone, monitoring the symbols that are dialed by the user, and reacting to the dialed symbols such as to provide multiple enhanced services that include incoming call handling and exchanging messages.

### FIELD OF THE INVENTION

The present invention relates to systems and methods for enhancing the capabilities of a simple phone.

### BACKGROUND OF THE INVENTION

Smart phones, including mobile (cellular phones) and IP phones, DECT phones and the like are complex and expensive. They usually include costly processors, digital signal processors, large memory units, multi-color displays and the like. These complex phones can support multiple functions such as but not limited to short message service (SMS) messages, menu based configuration. These complex phones also can allow a user to dial to a called party using symbols or letters, perform selective call screening and the like.

Many consumers have older, simpler phones. These simple phones support only few functions including performing phone calls, caller ID and can store only a limited amount of telephone numbers. A simple phone includes a caller ID display (or is connected to such a display) and usually includes a simple processor and a relatively limited capacity memory unit.

There is a growing need to enhance the capabilities of simple phones.

### SUMMARY OF THE PRESENT INVENTION

A communication unit adapted to provide enhanced services to a simple phone user, the communication unit includes a network interface, a simple phone interface and a terminal server module that is coupled to the network interface and to the simple phone interface. The communication unit is adapted to monitor symbols that are dialed by the user of the simple phone; determine if the dialed symbols form a predefined code that is associated with an enhanced service; selectively send information to be displayed on the display of the simple phone; monitor the symbols that are dialed by the user; and react to the dialed symbols such as to provide multiple enhanced services that include incoming call handling and exchanging messages.

A method for providing enhanced services to simple phone users, the method includes: monitoring symbols that are dialed by the user of the simple phone, determining if the dialed symbols form a predefined code that is associated with an enhanced service, selectively sending information to be displayed on the display of the simple phone, monitoring the symbols that are dialed by the user, and reacting to the dialed symbols such as to provide multiple enhanced services that include incoming call handling and exchanging messages.

### BRIEF DESCRIPTION OF THE DRAWINGS

The present invention will be understood and appreciated more fully from the following detailed description taken in conjunction with the drawings in which:

FIG. 1 illustrates a communication network according to an embodiment of the invention;

FIG. 2 illustrates a communication unit according to an embodiment of the invention;

FIG. 3 illustrates a method for enhancing the capabilities of a simple phone, according to an embodiment of the invention;

FIG. 4 illustrates a method for exchanging messages, according to an embodiment of the invention;

FIG. 5 illustrates a method for incoming call handling, according to an embodiment of the invention; and

FIG. 6 illustrates a method for defining the characteristics of the enhanced services, according to an embodiment of the invention.

### DETAILED DESCRIPTION OF PREFERRED EMBODIMENTS

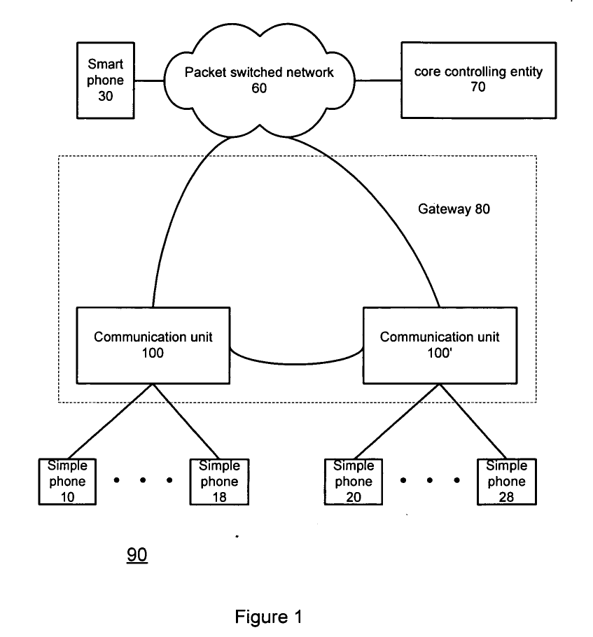

FIG. 1 illustrates a communication network 90 according to an embodiment of the invention.

Communication network 90 includes multiple simple phones such as simple phones 10-18 and 20-28, multiple communication units 100, 100′, central communication unit 65, packet switched network 60, core controlling entity 70 and smart phones 30. Packet switched network 60 can be a voice over IP network but this is not necessarily so. The core controlling entity 70 can be a core controlling entity, a SIP server and the like.

Communication units 100, 100′ form a gateway 80 that allows multiple simple phones 10-18 and 20-28 to communicate with packet switched network 60 and with core controlling entity 70.

Simple phones 10-18 are connected to communication unit 100 via two wires (POTS compliant) connections. Simple phones 20-28 are connected to communication unit 100′ via two wires (POTS compliant) connections. It is noted that other types of connections can also be used.

Communication unit 100 and communication unit 100′ are connected to each other and also to packet switched network 60. Packet switched network 60 is connected to the core controlling entity 70 and can also be connected to other devices such as smart phone 30, computers and the like.

Communication network 90 supports caller ID functionality. Caller ID networks as well as systems and devices that utilize the caller ID service are known in the art. Various caller ID standards were defined and include, for example, the Bellcore standard, the British Telecom Standard, the Cable Communication Association in U.K. standard, the European Telecommunication Standard's Institute (ETSI) standard (ETS 300 659-1, ETS 300 659-2, ETS 300 778-1). A caller ID supporting communication network must recognize the transmission of caller ID information. This can include detecting predefined codes, strings, tones, using DTMF methods, and the like.

The following U.S patent applications and U.S. patents, all being incorporated herein by reference, illustrate some caller ID services, as well as some implementations of the caller ID services: U.S. patent applications publication serial No. 2004/0209605 of Urban et al.; U.S. patent applications publication serial number 20050002513 of Pelletier et al.; U.S. patent applications publication serial number 20050013415 of Atknison et al.; U.S. patent applications publication serial No. 2005/0105510 of Reding et al.; U.S. patent applications publication serial No. 2005/0157860 of Schnarel et al.; U.S. patent applications publication serial No. 2005/0180553 of Moore; U.S. patent applications publication serial No. 2005/0190904 of Anupam et al.; U.S. Pat. No. 6,748,058 of Scwend et al.; U.S. Pat. No. 6,766,002 of Cannon; U.S. Pat. No. 6,782,086 of Clapper; U.S. Pat. No. 6,831,969 of Ju; and U.S. Pat. No. 6,885,739 of Cannon et al.

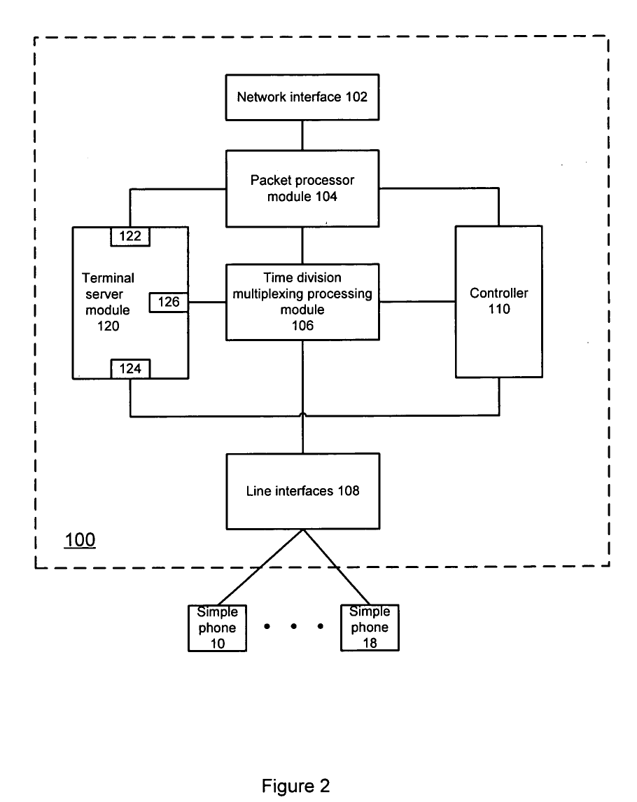

FIG. 2 illustrates a communication unit 100, according to an embodiment of the invention.

It is noted that each of the illustrated modules can be a hardware module, a software module or a combination of hardware and software modules. For example, the terminal server module 120 can be a software module and can be executed by one or more processors within control module 110.

Communication unit 100 includes network interface 102, packet processor module 104, time division multiplexing module 106, line interfaces 108, control module 110 and terminal server software module 120.

The packet processor module 104 is connected to the packet switched network 60 via network interface 102. The packet processor module 104 is also connected to the time division multiplexing module 106, line interfaces 108, control module 110 and to the terminal server module 120. The terminal server module 120 is also connected to the control module 110.

Those of skill in the art will appreciate that communication unit 100 can have different configurations, that the various modules can be hardware modules, software modules or a combination of both. It is also noted that at least two modules can be combined while one or more modules can be split.

Terminal server module 120 includes multiple interfaces 122-126. A first interface 122 receives packets (or information representative of packets) from the packet processor module 104. These packets carry configuration information that is received from a self-provisioning server. The self-provisioning server may be the communication unit itself. A second interface 124 is used for exchanging control signals with control module 110. A third interface 126 exchanges extended services related media with the time division multiplexing processing module 106. The time division multiplexing processing module 106 can also receive control DTMF signals from the simple phone 10

Terminal server module 120 includes an internal database 128 for storing information such as user related information, call processing information and configuration information. It is noted that database 128 can be located outside module 120.

Terminal server module 120 is also adapted to send displayed information to be displayed on the simple phone display. This displayed information is sent to the user according to the caller ID protocol, so that the simple phone can display the required information on the display.

Terminal server module 120 is also adapted to enable enhanced service configuration, to perform incoming call handling operations, to perform messages exchange operations and the like. Terminal server module 120 can also have DMTF detection functionalities, although this function can be executed by other modules such as the packet processor module 104.

The user can perform many operations by selecting between menus and the selecting between various options that are displayed on the caller ID display. The selection can be responsive to symbols that are dialed by the user. The menu display process can start by receiving a unique code (or string) from the user.

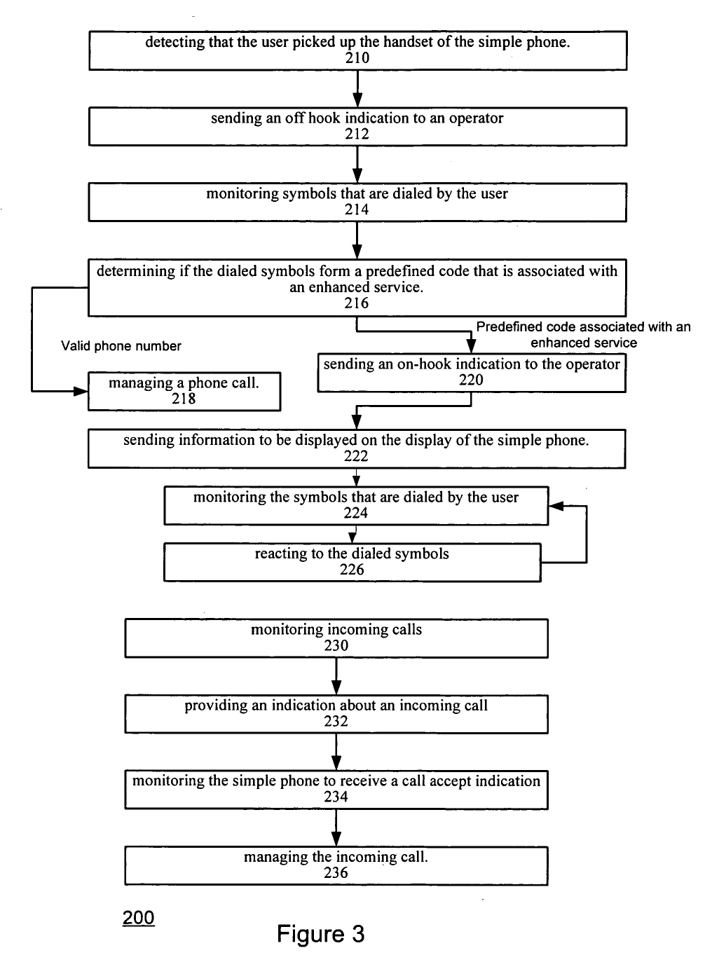

FIG. 3 illustrates a method 200 for enhancing the capabilities of a simple phone, according to an embodiment of the invention.

Method 200 starts by stage 210 of detecting that the user picked up the handset of the simple phone.

Stage 210 is followed by stage 212 of sending, conveniently by control module 110 (or in control of control module 110), an off hook indication to an operator such as core controlling entity 70.

Stage 212 is followed by stage 214 of monitoring, conveniently by the terminal server module 120, symbols that are dialed by the user. These symbols can form a code.

Stage 214 is followed by query stage 216 of determining if the dialed symbols form a predefined code that is associated with an enhanced service.

If the answer is negative (for example, the symbols that were dialed form a valid phone number) then stage 216 is followed by stage 218 of managing a phone call. In this case the terminal server module 120 does not interfere the call set-up process. The gateway 80 participates in the phone call establishment, maintenance and termination.

If the answer is positive (the user dialed a predefined code that is associated with an enhanced service) then stage 216 is followed by stages 220 and 222. Stage 220 includes sending an on-hook indication to the core controlling entity 70.

Stage 222 includes sending information to be displayed on the display of the simple phone. The information is transmitted and arranged in a caller ID compatible format, in order to allow the simple phone to display the desired information.

Conveniently stage 222 includes sending an initial menu to the simple phone. The initial menu is displayed on the display of the simple phone.

Stage 222 is followed by stage 224 of monitoring the symbols that are dialed by the user. Various symbols are associated with various options that are displayed on the display of the simple phone. For example, an initial menu can include a list of additional menus (also referred to as sub-menus, secondary menus and the like). The selection between the secondary menus is done by dialing a code (even a single symbol code) associated with that secondary menu.

Stage 224 is followed by stage 226 of reacting to the dialed code. It is noted that the reaction can include displaying information (for example displaying a selected sub-menu), defining how to respond to calls, dialing a displayed number (the number can retrieved from a memory unit within the communication module 100), blocking a certain call, configuring user services and the like.

Stage 226 can be followed by stage 224. It is noted that the number of iterations of stages 224 and 226 can be limited in advance, but this is not necessarily so. It if further noted that stage 226 can include terminating the phone call or the enhanced service.

According to an embodiment of the invention, if during the iterations of stages 224 and 226 an incoming call arrives it can be ignored of. Yet according to another embodiment of the invention the user can receive an indication of this incoming call and select whether to answer this call or not. The user can dial a certain code or hang off the call in order to answer the incoming call.

This embodiment is illustrated by stage 230 of monitoring incoming calls, stage 232 of providing an indication about an incoming call, stage 234 of monitoring signals provided by a simple phone and determining if a call accept indication is received, and stage 236 of selectively (in response to a request to accept the call) managing the incoming call.

According to an embodiment of the invention method 200 supports the storage and retrieval of a large number of phone numbers. A phone number can be retrieved from a database, displayed to the user, selected by the user and dialed by the communication unit 100.

The storage and retrieval can start by displaying, during an iteration of stage 224 or even during stage 222, a list of stored phone numbers. Each phone number can be associated with a name or even additional information such as address, email address, web site and the like.

The user can search for a number using various searching methods such as search by name, search by a portion of the number, search by address, or a sequential search.

During one or more iterations of stage 224 and 226 the number is displayed and is selected by the user.

The user can then enter a predefined code (one or more digits) and the selected number can be dialed, during an iteration of stage 226. The dialing includes sending an off-hook notification and then the selected number to core controlling entity 70. The gateway then can execute stage 218 of managing a phone call.

According to another embodiment of the invention the communication unit 100 can store textual messages aimed to the user of the simple phone. The user can retrieve the messages by using one or more message related menu, and the communication unit 100 can send the used a caller ID formatted message that will be displayed on the display of the simple phone.

According to yet a further embodiment of the invention the method 200 can associate digits that are dialed on the simple phone to editing instructions, thus allowing the user to edit messages.

The user will also be allowed to generate messages, delete messages, modify messages and to resent messages.

According to yet another embodiment of the invention the user can receive textual messages indicative of the reception of vocal messages.

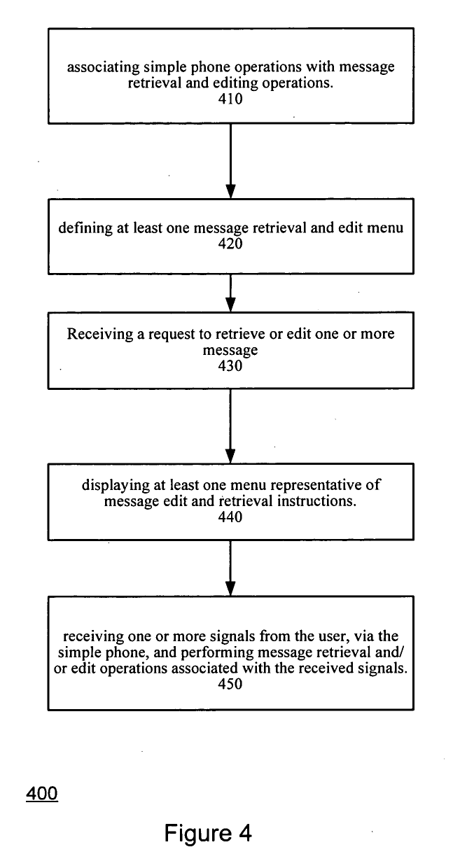

FIG. 4 illustrates a method 400 for exchanging messages, according to an embodiment of the invention.

Method 400 starts by stage 410 of associating simple phone operations with message retrieval and editing operations. Referring to the example set forth in previous figures, the communication cabinet 100 can be programmed or receive information that represent this associations. The user of the simple phone can receive audio and/or visual indications about these associations. The user can receive these associations by various means that do not involve using the simple phone. For example, the user can receive an enhanced services guide, can retrieve the information from a web site, and the like.

Stage 410 is followed by stage 420 of defining at least one message retrieval and edit menu. Conveniently these one or more message retrieval and edit menus are expressed by one or more instructions that can be processed by the simple phone such as to display the menu on the simple phone display. Referring to the examples set forth in previous figures, the communication unit 100 can be programmed or receive information that represent these definitions. The definitions can be the same to all users but this is not necessarily so.

Stage 420 is followed by stage 430 of receiving a request to retrieve or edit one or more message. Referring to the example set forth in previous figures, the user dials a predefined code (or string) that represents such a request. This string is received by the communication unit 100.

Stage 430 is followed by stage 440 of displaying at least one menu representative of message edit and retrieval instructions. Referring to the example set forth in previous figures, the communication unit 100 sends signals to the simple phone (such as caller ID compliant signals) that cause the menu to be displayed.

Stage 440 is followed by stage 450 of receiving one or more signals from the user, via the simple phone, and performing message retrieval and/or edit operations associated with the received signals. Referring to the example set forth in previous figures, the user dials a predefined code (or string) that represents message retrieval and/or edit operations such a request. This string is received by the communication unit 100.

According to another embodiment of the invention the communication unit 100 can allow a user to perform incoming call operations, such as automatic blocking of an incoming call, automatic diversion of the incoming call to a voice mail box, automatic forwarding the incoming call to another number, and the like. These incoming call operations can be defined per incoming number.

Various methods can be used to associate incoming numbers to a required incoming call operation. Conveniently, the communication unit 100 is capable to determine the caller ID of the incoming call, search a database to determine whether a certain incoming call operation should be executed, and execute that operation.

The user can define the caller ID as well as the incoming call operations associated with them by using menus displayed on the simple phone display. It is noted that the incoming call operations can be applied per one incoming call, per a group of incoming calls or per all incoming calls. In addition different incoming call operations can be defined in response to information other than the caller identity. The additional information can relate to the number of calls from a certain caller, to the time and date of the incoming call and the like.

The communication module 100 and especially the terminal server module 120 can apply one or more incoming call operation before applying the ring signal to the user's line.

It is noted that the communication unit 100 can cause the simple phone to provide an audio and/or visual indication of the diverted/blocked call.

Conveniently, if the call is blocked the terminal server module 120 does not pass the ring signal towards the user simple phone.

Conveniently, if the call is forwarded or transferred to a voice mail the terminal server module 120 will not pass the ring signal towards the simple phone and will generate the sequence of protocol messages towards soft-switch 70 in order to cause the core controlling entity 70 to perform the required actions.

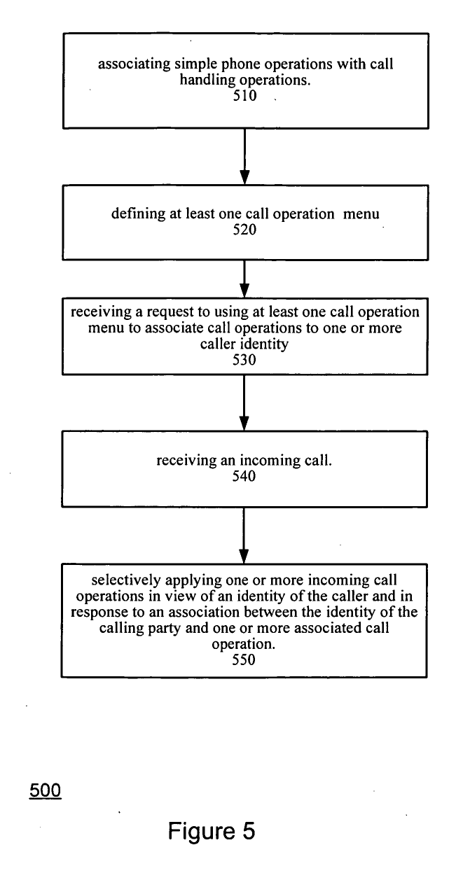

FIG. 5 illustrates a method 500 for incoming call handling, according to an embodiment of the invention.

Method 500 starts by stage 510 of associating simple phone operations with call handling operations. Referring to the example set forth in previous figures, the communication cabinet 100 can be programmed or receive information that represent this associations. The user of the simple phone can receive audio and/or visual indications about these associations. The user can receive these associations by various means that do not involve using the simple phone. For example, the user can receive an enhanced services guide, can retrieve the information from a web site, and the like.

Stage 510 is followed by stage 520 of defining at least one call operation menu. Conveniently these one or more call operation menus are expressed by one or more instructions that can be processed by the simple phone such as to display the menu on the simple phone display. Referring to the examples set forth in previous figures, the communication unit 100 can be programmed or receive information that represent these definitions. The definitions can be the same to all users but this is not necessarily so.

Stage 520 is followed by stage 530 of receiving a request to using at least one call operation menu to associate call operations to one or more caller identity. Referring to the example set forth in previous figures, the user dials a predefined code (or string) that represents such a request. This string is received by the communication unit 100.

Stage 530 is followed by stage 540 receiving an incoming call.

Stage 540 includes selectively applying one or more incoming call operations in view of an identity of the caller and in response to an association between the identity of the calling party and one or more associated call operation.

Referring to the example set forth in previous figures, the communication unit 100 receives a call to a certain user, searches for the incoming call definitions associated with that user and applies one or more incoming call operations.

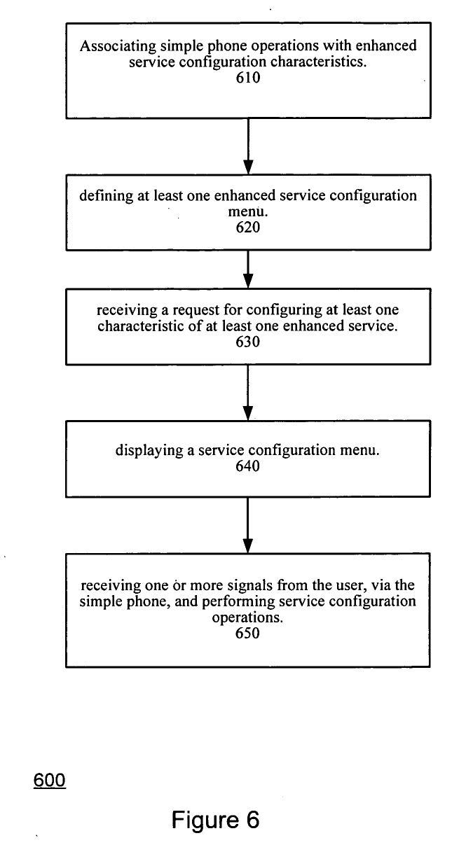

FIG. 6 illustrates a method 600 for configuring the characteristics of the enhanced services, according to an embodiment of the invention. These characteristics can include the content of the menus, visual aspects of the menus, associations between strings (codes) and instructions, content of visual messages, audio characteristics, and the like.

Method 600 starts by stage 610 of associating simple phone operations with enhanced service configuration characteristics. Referring to the example set forth in previous figures, the communication cabinet 100 can be programmed or receive information that represent this associations. The user of the simple phone can receive audio and/or visual indications about these associations. The user can receive these associations by various means that do not involve using the simple phone. For example, the user can receive an enhanced services guide, can retrieve the information from a web site, and the like.

Stage 610 is followed by stage 620 of defining at least one enhanced service configuration menu. Conveniently these one or more service configuration menus are expressed by one or more instructions that can be processed by the simple phone such as to display the menu on the simple phone display. Referring to the examples set forth in previous figures, the communication unit 100 can be programmed or receive information that represent these definitions. The definitions can be the same to all users but this is not necessarily so.

Stage 620 is followed by stage 630 of receiving a request for configuring at least one characteristic of at least one enhanced service. Referring to the example set forth in previous figures, the user dials a predefined code (or string) that represents such a request. This string is received by the communication unit 100.

Stage 630 is followed by stage 640 of displaying a service configuration menu. Referring to the example set forth in previous figures, the communication unit 100 sends signals to the simple phone (such as caller ID compliant signals) that cause the menu to be displayed.

Stage 640 is followed by stage 650 of receiving one or more signals from the user, via the simple phone, and performing service configuration operations. The new configuration is stored at the communication unit and is used when an enhanced service is later used.

Referring to the example set forth in previous figures, the user dials a predefined code (or string) that represents a service configuration operation. This string is received by the communication unit 100.

Conveniently, the services and configurations may be provisioned by user using a web interface where the configuration information is passed over network interface.

Those of skill in Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

We claim:

1. A method for providing enhanced services to simple phone users, the method comprises: monitoring symbols that are dialed by the user of the simple phone; determining if the dialed symbols form a predefined code that is associated with an enhanced service; selectively sending information to be displayed on the display of the simple phone; monitoring the symbols that are dialed by the user; and reacting to the dialed symbols such as to provide multiple enhanced services that comprise incoming call handling and exchanging messages.

2. The method according to claim 1 whereas the stage of reacting comprises displaying a main menu and in response to symbols that are dialed by the user displaying at least one secondary menu on the display of the simple phone.

3. The method according to claim 1 further comprising associating simple phone operations with message retrieval and editing operations and associating simple phone operations with call handling operations.

4. The method according to claim 1 further comprising defining at least one call operation menu and defining at least one message retrieval and edit menu.

5. The method according to claim 1 further comprising monitoring incoming calls, providing an indication about an incoming call, monitoring signals provided by a simple phone, determining if a call accept indication is received; and selectively managing the incoming call.

6. The method according to claim 1 further retrieving a phone number from a communication unit, by displaying at least one menu and monitoring signals sent from the simple phone, and dialing the retrieved number.

7. The method according to claim 1 further comprising providing service configuration.

8. The method according to claim 7 further comprising associating simple phone operations with enhanced service configuration characteristics

9. The method according to claim 1 further comprising defining at least one enhanced service configuration menu.

10. A communication unit adapted to provide enhanced services to a simple phone user, the communication unit comprises a network interface, a simple phone interface and a terminal server module coupled to the network interface and to the simple phone interface, whereas the communication unit is adapted to monitor symbols that are dialed by the user of the simple phone, determine if the dialed symbols form a predefined code that is associated with an enhanced service, selectively send information to be displayed on the display of the simple phone, monitor the symbols that are dialed by the user, and react to the dialed symbols such as to provide multiple enhanced services that comprise incoming call handling and exchanging messages.

11. The communication unit according to claim 10 whereas the information to be displayed on the display of the simple phone comprises a main menu and at least one secondary menu on the display of the simple phone.

12. The communication unit according to claim 10 further adapted to associate simple phone operations with message retrieval and editing operations and to associate simple phone operations with call handling operations.

13. The communication unit according to claim 10 further adapted to define at least one call operation menu and define at least one message retrieval and edit menu.

14. The communication unit according to claim 10 further adapted to monitor incoming calls, provide an indication about an incoming call, monitor signals provided by a simple phone, determine if a call accept indication is received; and selectively manage the incoming call.

15. The communication unit according to claim 10 further adapted to retrieve a phone number, sending information that displays at least one menu, monitor signals sent from the simple phone, and dial the retrieved number.

16. The communication unit according to claim 10 further adapted to support service configuration.

17. The communication unit according to claim 16 further adapted to associate simple phone operations with enhanced service configuration characteristics

18. The communication unit according to claim 10 further adapted to define at least one enhanced service configuration menu.
